(19) United States
(12) Patent Application Publication
(10) Pub. No.: US 2017/0302618 A1
(43) Pub. Date: Oct. 19, 2017

(54) Automated Generation of Control Plane Logic in a Diameter Network

(71) Applicant: Virtual Network Elements, Inc., Beverly, MA (US)

(72) Inventor: Kalidas Porika, Nashua, MA (US)

(73) Assignee: Virtual Network Element, Inc., Beverly, MA (US)

(21) Appl. No.: 15/133,191

(22) Filed: Apr. 19, 2016

(51) Int. Cl. H04L 29/12; H04W 8/10; H04L 29/06

(52) U.S. Cl. CPC H04L 61/203; H04L 69/22; H04W 8/10

(57) ABSTRACT

The present invention relates to computer implemented processes affected through a set of computer operations stored in a memory device and executed using a hardware processor. The embodiments disclosed herein comprise methods as well a computer hardware system comprising a hardware processor capable of executing the method steps. The computer operations facilitate processes for automating the creation of call flows and the instantaneous routing of calls within a wireless network operating over a Diameter protocol or a Diameter protocol extension. The call flows are generated by reading metadata stored in a finite state machine, which is required to be kept by the Diameter protocol standards.

### FIELD

The present invention relates generally to a system and method for automating the creation of control plane logic that governs call or message flows within a Diameter-based network.

### BACKGROUND

In legacy networks, such AMPS and 2G, voice calls were provided over a switched, circuit-style network. As mobile phone usage became more ubiquitous, network developers and standards bodies responded by adopting the IP Multimedia Subsystem, also known as the IP Multimedia Core Network Subsystem (“IMS”), as the architectural framework for delivering IP multimedia services, which include data, voice, and video.

The signaling protocol for IMS in the 3G network, as well as in the Evolved Packet Core (“EPC”) networks for 4G LTE, is the DIAMETER protocol, which was adopted by the Internet Engineering Task Force as document number RFC 6733, the entire contents of which are hereby incorporated by reference. The Diameter base protocol, like its predecessor, the RADIUS protocol, is intended to provide an authentication, authorization, and accounting framework (“AAA”) for applications such as network access or IP mobility in both local and roaming situations.

In modern 3G, 4G, or 5G networks, there are myriad network elements that provide services, such as voice, data, and video, to network subscribers. These network elements work with each other over defined protocols. At any given time, a network can be running on a base protocol, for example the DIAMETER Base Protocol, while simultaneously using protocol extensions, which integrate with the Diameter Base protocol, to govern communication between each of the myriad network elements.

The Diameter base protocol is an authentication, authorization, and accounting protocol. The purpose of an authentication, authorization, and accounting framework is to provide access control as well as secure data transmission. In current wireless networks that require authentication, authorization, and accounting functionality, the Diameter protocol allows network designers to define their own own extensions, which can run on top of the Diameter base protocol. In practice, hundreds of these extensions have been developed and adopted as standards. By way of example, the ETSI TS 129 family of standards, which operates in Universal Mobile Telecommunications (“UMTS”) or Long Term Evolution (“LTE”) networks, sometimes referred to as the 3GPP TS 29.xxx family of standards, includes 3GPP TS 29.214 version 12.9.0 Release 12, entitled “Policy and charging control over Rx reference point,” (“Rx extension”), the entire contents of which are hereby incorporated by reference. An alternate example of a network extension is 3GPP TS 29.212 version 7.4.0 Release 7 entitled “Policy and charging control over Gx reference point,” (“Gx extension”), the entire contents of which are hereby incorporated by reference. For a complete list of all of the 3GPP TS 29.xxx standards, see http://www.3gpp.org/DynaReport/29-series.htm, the entire contents of all of the standards listed therein are hereby incorporated by reference.

Every element within an IMS network is communicatively coupled to an encoder and a decoder, which is used, respectively, to encode messages before they are transmitted or decode messages upon receipt. Encoding and decoding is part of the security protections offered by the Diameter based protocols. Similarly, all encoders and decoders are coupled to a control plane, which is a unique set of logic designed to forward data within the network.

One of the challenges of this model is—network elements within the IMS network use different Diameter protocol extensions to communicate with one another. If for example, a data exchange was transpiring between an Application Function network element and a Policy and Charging Rules Function element, that exchange would be occurring over an Rx Diameter protocol extension. If, on the other hand, the data exchange was occurring between the Policy and Charging Rules Function element and a Policy and Charging Enforcement Function element, that exchange would transpire using a Gx Diameter protocol extension. This variability has at least two drawbacks: (1) the complexity of programming encoders and decoders, as well as the control plane logic coupled thereto, for each of the individual network elements, and there are hundreds, must be done manually and individually, which is costly; and (2) data speed is minimized because messages being routed to any element that is further than a one-hop neighbor must be encoded and decoded multiple times depending upon the Diameter protocol extensions existing along the pathway traversed by the data.

From the control plane's perspective, it would thus be advantageous to find a way to automate some of the creation of the control plane logic. Additionally, it would be beneficial to maximize data transport efficiency within the network.

### SUMMARY OF THE INVENTION

The present invention relates to computer implemented processes affected through a set of computer operations stored in a memory device and executed using a hardware processor. The embodiments disclosed herein comprise methods as well a computer hardware system comprising a hardware processor capable of executing the method steps. The computer operations facilitate processes for automating the creation of call flows and the instantaneous routing of calls within a wireless network operating over a Diameter protocol or a Diameter protocol extension. The call flows are generated by reading metadata stored in a finite state machine, which is required to be kept by the Diameter protocol standards.

In alternate embodiments, the present invention discloses a computer hardware system comprising a hardware processor including a code generator wherein the hardware processor is configured to initiate or perform processes for automating the creation of call flows and the instantaneous routing of calls within a wireless network operating over a Diameter protocol or a Diameter protocol extension. The call flows are generated by reading metadata stored in a finite state machine, which is required to be kept by the Diameter protocol standards.

### BRIEF DESCRIPTION OF THE DRAWINGS

FIG. 1 is a block diagram showing a portion of the network layers and the communicative couplings between the layers in a wireless network.

FIG. 2 is a block diagram showing connections between exemplary wireless network elements in a network configured to transmit and receive Diameter protocol messages.

FIG. 3 is a block diagram showing the structure of a Diameter protocol data packet.

FIG. 4 is a block diagram showing the relationship between the Diameter interface, commands, AVPs, and optionally group AVPs.

FIG. 5 is a block diagram showing a call, or message, flow between network elements according to the embodiments of the present invention.

FIG. 6 is a block diagram of an instance of a computer system suitable for implementing embodiments of the present disclosure.

FIG. 7 is flow chart showing steps of a method embodiment of the present invention.

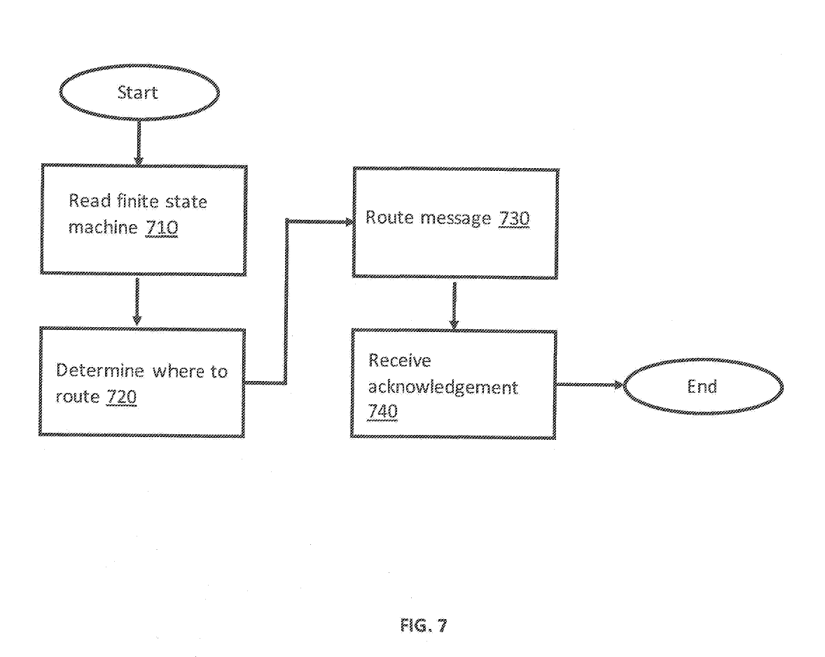

### DETAILED DESCRIPTION

In an OSI network, the presentation layer establishes context between application-layer entities, in which the application-layer entities may use different syntax and semantics if the presentation service provides a bit mapping between them. If a mapping is available, presentation service data units are encapsulated into session protocol data units, and passed down the protocol stack. This layer provides independence from data representation (e.g., encryption) by translating between application and network formats. The presentation layer transforms data into a form that the application accepts. This layer formats and encrypts data to be sent across a network

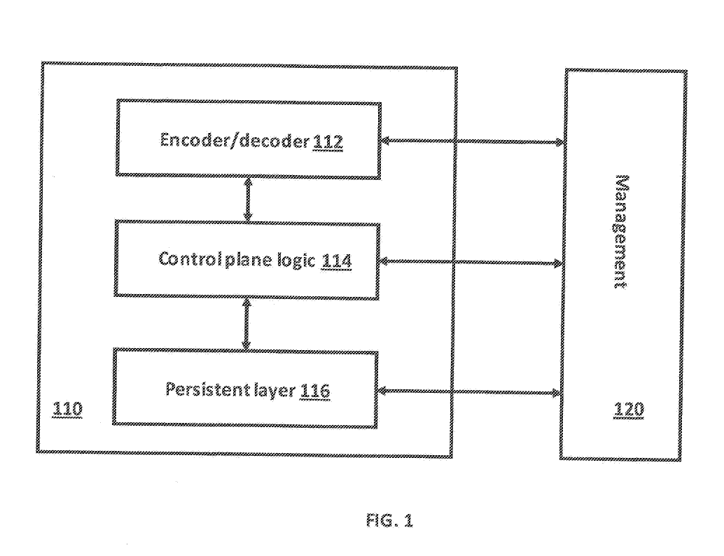

FIG. 1 shows a portion of the presentation layer, namely the control plane 110 and the management plane 120 of a wireless network element. As can be seen in FIG. 1, the control plane 110 is further comprised of an encoder/decoder 112, control plane logic 114, and a persistent layer 116. The encoder/decoder 112, also sometimes called a protocol wrapper, is the top level of the control plane 110. The main function of the encoder/decoder 112 is to translate incoming and outgoing messages into a format that can be understood by the application layer, which although is not pictured, is communicatively coupled to the control plane 110 in an OSI wireless network. One of the reasons that wireless networks must have an encoder/decoder 112 is because there are myriad protocols used to transmit data. As such, the data structure will vary depending on the protocol used.

The control plane logic 114 processes commands, makes logical decisions and evaluations, and performs calculations. It also moves and processes data between the encoder/decoder 112 and the persistent layer 116. The control plane 114 is the logic that controls forwarding behavior. Examples of control plane 114 functions include routing protocols as well as logic for configuring network middle boxes. The persistent layer 116 is comprised of memory and processors used to store and retrieve information. NoSQL, Graphic Database, in-memory database or similar memory devices known to those of skill in the art can be used in the persistent layer 116.

The control plane 114 makes decisions about where traffic is sent. Control plane 114 packets are destined to or locally originated by a router. The control plane 114 functions include the system configuration, management, and exchange of routing table information. A route controller exchanges topology information with other routers and constructs a routing table based on a routing protocol, for example, RIP, OSPF or BGP. Control plane 114 packets are processed by the router to update the routing table information. The control plane 114 manages the signaling within the network.

This invention relates generally to a system and method for automating the creation of control plane logic. Understanding how the control plane logic could automatically be generated, and what this invention contributes to the art, requires a brief discussion of the Diameter message format. A Diameter message is the base unit to send a command or deliver a notification to other Diameter nodes. For different purposes, the Diameter protocol has defined several types of Diameter messages, which are identified by their command code. For example, an Accounting-Request message recognizes that the message carries accounting-related information, while a Capability-Exchange-Request message recognizes that the message carries capability information of the Diameter node sending the message. Because the message exchange style of Diameter is synchronous, each message has its corresponding counterpart, which shares the same command code. In both previous examples, the receiver of a request message prepares a corollary answer message and sends it to the original sender, e.g., an Accounting-Answer or a Capability-Exchange Answer.

The command code is used to identify the intention of a message, but the actual data is carried by a set of Attribute-Value-Pairs (AVPs). These AVPs carry the details of the message Accounting AA as well as routing, security, and capability information being exchanged by two Diameter nodes. The Diameter protocol has a predefined a set of common attributes, wherein each attribute has a corresponding semantic. In addition, each AVP is associated with an AVP Data Format, which is defined within the Diameter protocol (for example, OctetString, Integer32). The value of each attribute, therefore, follows the data format.

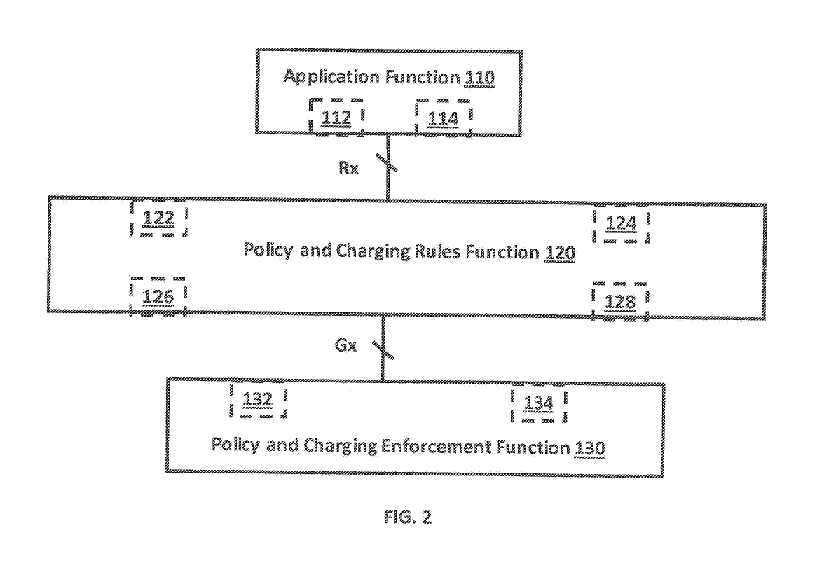

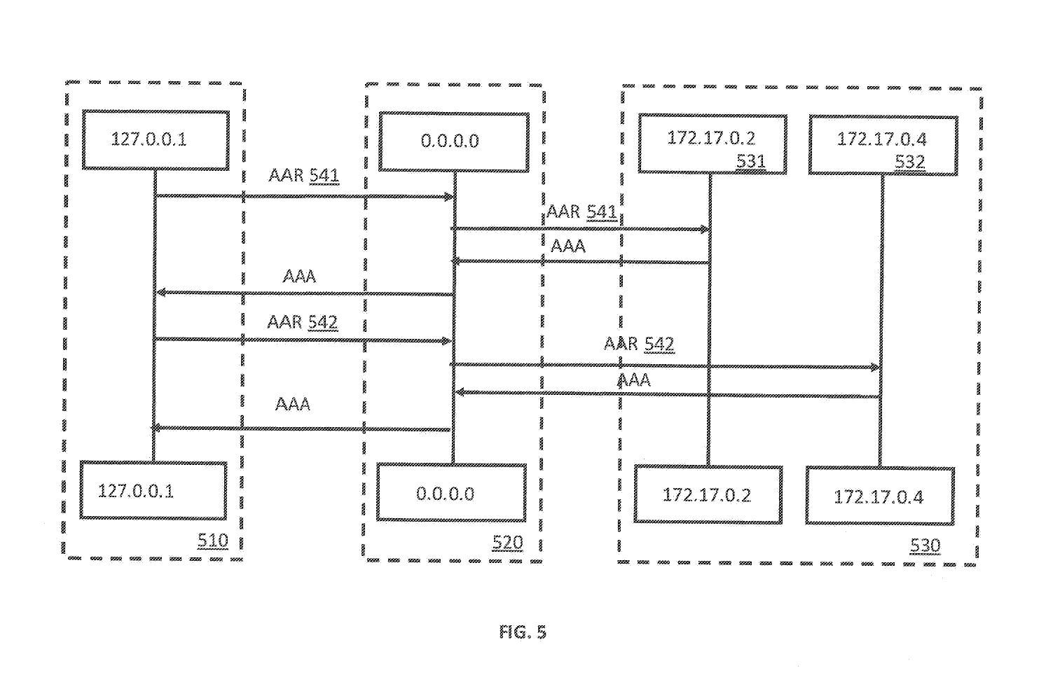

One example, which will be used as an exemplary embodiment, is a portion of a wireless network that would operate using an Rx extension protocol. Some network elements, for example depicted in FIGS. 2 and 5 could communicate using an Rx protocol. These figures, however, and the steps/functions of the description related to the Rx embodiment are used as a general example of how the automated control plane logic generator could work. The principles discussed throughout this application are generally applicable to all known or future created Diameter base protocols and Diameter base protocol extensions.

FIG. 2 shows a portion of an IMS network including an Application Function (“AF”) element 210, a Policy and Charging Rules Function (“PCRF”) element 220, and a Policy and Charging Enforcement Function (“PCEF”) element 230. The AF 210, PCRF 220, and PCEF 230 elements each have an encoder and a decoder communicatively coupled thereto. The AF element 210 has an AF encoder 212 and AF decoder 214 therein. Similarly, the PCRF has PCRF encoders 222 and 226 and PCRF decoders 224 and 228. And the PCEF has PCEF encoder 232 and PCEF decoder 234.

In current implementations, the network is designed so that the AF element 210 communicates with the PCRF element 220 using an Rx extension protocol. Similarly, the PCRF element 220 communicates with the PCEF element 230 using a Gx extension protocol. Accordingly, AF encoder 212 and PCRF encoder 222 will be programmed by network engineers prior to deployment to be able to encode Diameter base protocol messages as well as Rx extension protocol messages. AF decoder 214 and PCRF decoder 224 will be programmed to decode Diameter base protocol messages and Rx extension protocol messages. PCRF encoder 226 and PCEF encoder 232 will be programmed to encode Diameter base protocol messages and Gx extension protocol messages. PCRF decoder 228 and PCEF decoder 232 will be programmed to decode Diameter base protocol messages and Gx extension protocol messages.

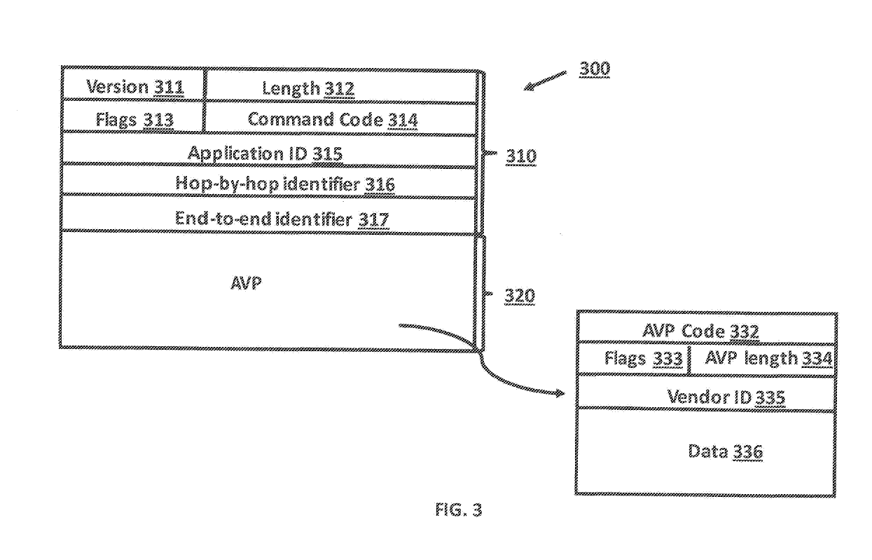

FIG. 3 shows the Diameter packet 300 format for data messages being exchanged according to the Diameter base and Diameter extension protocols. As can be seen in FIG. 3, the Diameter packet 300 is comprised of a header 310 and a payload 320. The header 310 includes information regarding, among other things, a command code 314 and an application ID 315. Every Diameter message must contain a command code in its header's command code 314 field, which is used to determine the action to be taken for a particular message. See generally Ch. 3, Diameter base protocol. The application ID 315 signifies which protocol extension, if any, is being used to for data transmission.

The Diameter protocol has many application IDs 315 and many command codes 314 that correspond to these application IDs 315. There are thousands of combinations that can be created between application IDs 315 and command codes 314. The combination of application IDs 315 and command codes 314 is used to create an interface between elements. Moreover, the application ID 315 and the command code 314, when taken together, uniquely identify a command contained within the header 310.

The payload 320 is comprised of an attribute value pair or AVP. Diameter AVPs 320 carry specific authentication, accounting, authorization, and routing information as well as configuration details for the request and reply. See generally Chapter 4, Diameter base protocol. A breakdown of the AVP format 330 is shown in FIG. 3. As can be seen, the AVP 320 includes an AVP code 332, flags 333, an AVP length 334, a vendor identification 335, and data 336.

The information that must be contained within the AVP 320 depends directly upon the command code 314. The Diameter base protocol and the Diameter extension protocols delineate certain rules regarding whether a particular data filed must be included, may be included, or must not be included within an AVP 320 for each of the possible command codes 314 that could appear in the header 310. Specifically, “[e]very command code MUST include a corresponding command code format specification which is used to define the AVPs that MUST or MAY be present when sending this message.” See Ch. 3.2 Diameter base protocol.

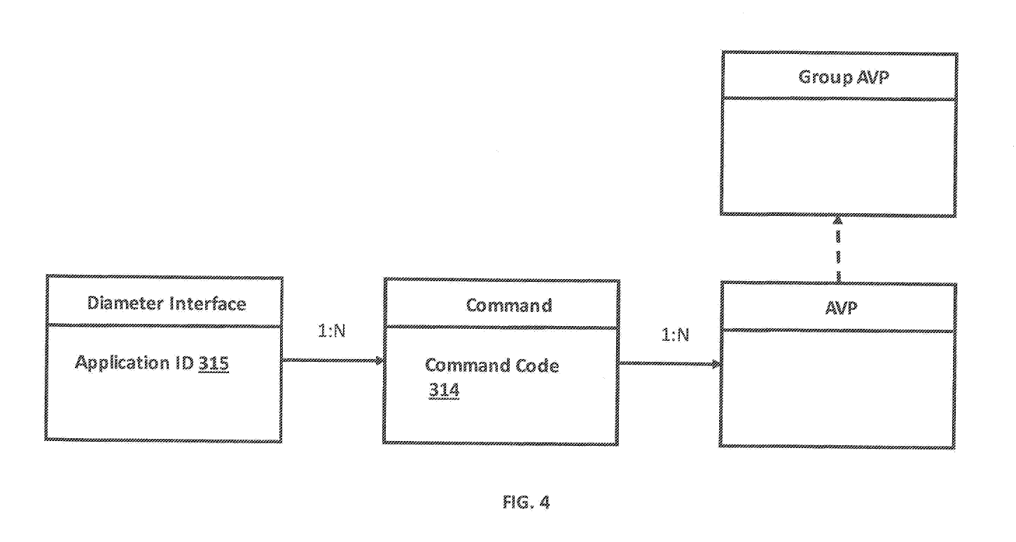

FIG. 4 shows the relationship between the Diameter interface, commands, AVPs, and optionally group AVPs. Each Diameter interface has a unique application ID, which is an unsigned 32-bit integer. By way of example, the application ID for the Diameter base protocol is 0. The application ID for the RX protocol extension is 16777236. The application ID for the Gx protocol extension is 16777238. Referring back to FIG. 3, the application ID 315 portion of the header, which is a 32-bit unsigned integer, indicates which protocol interface applies to the data packet 300.

Turning back to FIG. 4, for each Diameter interface there are numerous commands, also called verbs, associated with that interface. For example, in the Diameter base protocol, there are fourteen commands. Each command is uniquely identified by its command code 314. Table 1 shows the command name, its abbreviation, and the command code for the fourteen Diameter base protocol messages.

| Command Name | Abbreviation | Command Code |
|---|---|---|
| Abort-Session-Request | ASR | 274 |
| Abort-Session-Answer | ASA | 274 |
| Accounting-Request | ACR | 271 |
| Accounting-Answer | ACA | 271 |
| Capabilities-Exchange- | CER | 257 |
| Request | | |
| Capabilities-Exchange- | CEA | 257 |
| Answer | | |
| Device-Watchdog-Request | DWR | 280 |
| Device-Watchdog-Answer | DWA | 280 |
| Disconnect-Peer-Request | DPR | 282 |
| Disconnect-Peer-Answer | DPR | 282 |
| Re-Auth-Request | RAR | 258 |
| Re-Auth-Answer | RAA | 258 |
| Session-Termination- | STR | 275 |
| Request | | |
| Session-Termination- | STA | 275 |
| Answer | | |

As can be seen in FIG. 3, the Command Code 314 is part of the header 310 of a Diameter data packet 300. The command code 314 is a 24-bit unsigned integer. As can be seen in Table 1, under the Diameter protocol, every request has a corresponding answer. This parity lends itself to a Boolean representation wherein the answer/request pairs can be entered into a database as a single bit in the Request field of the message.

The Diameter Base Protocol also requires that a finite state machine must be observed by all Diameter implementations. See Diameter Base Protocol, Ch. 5.6 et seq. “Each Diameter node MUST follow the state machine described below when communicating with each peer.” Id. As a practical matter, in Diameter networks, this means that each network element must store an entry for every message it sends or receives within the network in a state machine. In some Diameter networks, each network element may keep its own independent state machine. Alternatively, network elements could aggregate the collection of data entries corresponding to each message sent or received in a shared state machine.

In terms of the entries in the state machines, they would be of the format: SOURCE->>DESTINATION: Verb_[Payload]_Time_Stamp; wherein SOURCE is an identifier associated with the sending element; DESITINATION would be an identifier associated with the destination element; Verb would be the Command Code within the Diameter protocol or any of its extensions; Payload would be the actual message content; and Time_Stamp would be a time and date stamp.

In embodiments of this invention, we take this metadata stored in the various Diameter state machines and create the control plane 114 logic therefrom. Currently, in the prior art, call flows are created manually by coders who write specific code that is coupled to the finite state machines. These manually generated call flow code segments perform a specific call flow based on the type of call being received or on the specific state of the call stored within the finite state machine. Rather than manually code these call flows, embodiments herein automatically generate a call flow from the data stored within the finite state machines.

These embodiments capitalize on the fact that each network element can be uniquely identified based on its protocol, or protocol extension, and its interactions with other network elements. We gather all the call flows, i.e., all of the states for a particular network element and create a finite state machine, which defines all of the interactions of that network element with other network elements. We read the finite state machine metadata and auto generate the code that can be executed for that network element on the network hardware.

The resulting embodiments are middleware used to communicate among the various Diameter network elements. “Middleware” is a general term for software that serves to “glue together” separate, often complex and already existing, programs. Some software components that are frequently connected with middleware include enterprise applications and Web services.

FIG. 5 is a block diagram of a call, or message, flow between a server 510, a Diameter routing agent 520 and multiple partitions within a PCRF 530. For purposes of illustration, and without limitation, the server 510 could be an Application Function (“AF”). While embodiments described herein describe a server 510 communicatively coupled to a PCRF 530 via a Diameter routing agent 520, those of skill in the art will recognize that the PCRF 530 could be replaced with similar policy routing agents found in a current or future Evolved Packet Core (“EPC”) network.

In a typical EPC network, the server would send messages to a gateway, which in turn would perform the routing functions that are required to send the message to a PCRF 530 or similar policy controlling agent. The PCRF 530 is a software node designated in real-time to determine policy rules in a multimedia network. As a policy tool, the PCRF 530 plays a central role in next-generation networks. The PCRF 530 is a software component that operates at the network core and accesses subscriber databases and other specialized functions, such as a charging system, in a centralized manner. Because it operates in real time, the PCRF 530 has an increased strategic significance and broader potential role than traditional policy engines.

The PCRF 530 is the part of the network architecture that aggregates information to and from the network, operational support systems, and other sources (such as portals) in real time, supporting the creation of rules and then automatically making policy decisions for each subscriber who is active on the network. In this type of network, it is possible to offer multiple services, quality of service levels, and charging rules. The PCRF 530 can provide a network agnostic solution (wire line and wireless) and can also enable a multi-dimensional approach, which helps in creating a lucrative and innovative platform for operators.

The PCRF 530 can also be integrated with different platforms, such as billing, rating, charging, and subscriber databases. It can also be deployed as a standalone entity. The PCRF 530 plays a key role in Voice-over-LTE as a mediator of network resources for the IP Multimedia Systems network for establishing the calls and allocating the requested bandwidth to the call bearer with configured attributes. This enables an operator to offer differentiated voice services to their user(s) by charging a premium. Operators also have an opportunity to use the PCRF 530 for prioritizing the calls to emergency numbers in the next-generation networks.

PCRFs 530 in modern networks are often portioned, each partition having a distinct IP address. When a routing agent or gateway routes calls or messages from a server to the PCRF 530, it is most efficient if the routing agent can route the calls or messages to the specific partition within the PCRF 530 that is in charge of handling call traffic flow for the particular subscriber. In embodiments of the present invention, the typical gateway can be replaced by a custom-built Diameter routing agent 520.

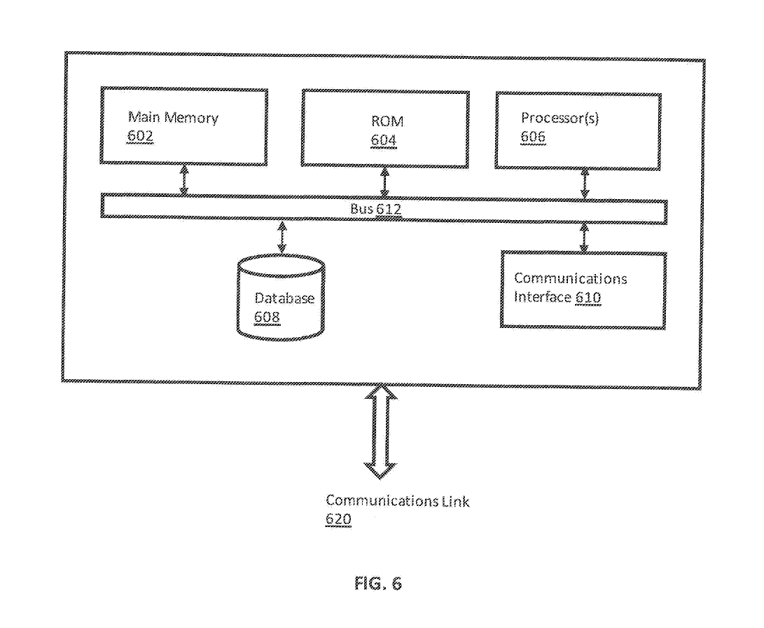

FIG. 6 is a schematic showing some of the elements that could comprise the Diameter routing agent 520. Specifically, the Diameter routing agent 520 could include a bus 612, a main memory 602, and optionally a Read Only Memory 604 for storing executable instructions, which could be software or middleware, for achieving the performance described by embodiments herein. Either of the memory 602 or ROM 604 or both could be used to store the mandated state machine required by the Diameter protocol.

The Diameter routing agent 520 is further comprised of a processor 606 for executing the instructions stored in memory 602 and a database 608 communicatively coupled thereto. The processor 606 has computer executable instructions that enable it to extract key pieces of information from the state machine, which stores metadata about all message/call traffic within a network, and to populate the database 608 with some of those metadata.

In terms of creating the routing table that will be stored in a memory storage unit 602, 604, or 608 communicatively coupled to the Diameter routing agent 520, the first step is reading the finite state machine, which is required to be kept by Diameter networks. These state machines have a log of all message routing traffic details for subscribers located within the network. Embodiments monitor all data and call traffic for subscribers within its network, meaning metadata for all calls and messages sent within the subscriber network are stored within in a finite state machine located within the memory storage unit 602 or the ROM 604.

The metadata associated with each entry within the finite state machines includes, but is not limited to, some or all of the following information: log entry number, subscriber ID, subscriber ID type, IPv6 Prefix, source ID, destination ID, Target Server IP address, Target Server Port, Hop ID, End ID, Application ID, Session ID, Authorization Application ID, Origin Host, origin Realm, Destination Host, Destination Realm, Media Host Description Indicators, Service Information Status, SIP Forking Indication, Specific Action, Service URN, Sponsored Connectivity Data, MPS Identifier, GCS Identifier, Protocol Request Type, Required Access Information, Origin State ID, Proxy Information, Route Record, IP Domain ID, Subscription ID, Reservation Priority, Called Station ID, Framed IP Address, Framed IPv6 Prefix, or Supported Features. Embodiments of the present invention read some or all of these metadata from the finite state machine.

After reading the state machine, the embodiments extract the necessary pieces of metadata required to populate the database 608, which is communicatively coupled to the Diameter routing agent 520.

In some embodiments, entries within the routing table could be created by the processor 606 by using one or more of the following metadata to performing routing functions: subscriber ID, subscriber type, source ID, destination ID, or Framed IPv6 Prefix. In some embodiments, the Framed IPv6 information for each call can be stored in a subscriber look-up table. The software or middleware of the current embodiments correlates each Framed IPv6 Prefix, on a per message basis, to a partition within the PCRF 530 to which the message or call must be routed.

In alternate embodiments, the message or call forwarding can be performed by the Diameter routing agent 520 based on the application ID, the command code or an additional attribute on the payload. In additional embodiments, the Dynamic routing agent 520 can perform a dynamic lookup in order to determine the PCRF 530 partition to which it should route messages or calls received from out-of-network subscribers. This dynamic lookup could be accomplished by communicatively coupling to a Home Subscriber Server (“HSS”), which provides metadata for out-of-network subscribers who have not yet sent messages sufficient to enable the creation of entries within the state machine regarding the metadata associated with that particular subscriber.

When the Dynamic routing agent 520 communicatively couples to the HSS, it obtains the information sufficient to enable it to determine the PCRF partition to which it should route data for that particular out-of-network subscriber. Once the Dynamic routing agent 520 determines this information for the particular out-of-network subscriber, it stores that information within the database 608 so that it can facilitate routing for the out-of-network subscriber in the future.

Although embodiments described herein have referred to a PCRF 530, which uses an Rx protocol for communication between itself and the server, in alternate embodiments, the concepts described herein could be used with additional protocols such as Gx, Gxx, and additional Diameter protocol extensions known to those of skill in the art.

Embodiments of the present invention are comprised of computer executable instructions stored in a processor 606 that enable them to automatically generate an xml-like syntax, which is used to create a call/message flow for efficiently routing data to the proper partition within the PCRF 530, or in alternate embodiments policy agent. These embodiments use one or more of the following metadata to generate the call/message flow: IPv6 Prefix, application ID, command code, attributes within the payload, or subscriber location function.

FIG. 5 depicts two exemplary message flows using the Diameter routing agent 520 of the present invention. The first routing action shown in FIG. 5 is the server 510 sending a first message 541, which for purposes of illustration is an authentication, authorization request (“AAR”), to the Diameter routing agent 520. As can be seen in FIG. 5, the first message is forwarded to the Diameter Routing Agent 520, wherein the Diameter routing agent 520 reads the automated call/message flow information, which is stored in database 608.

The message format of the first message 541 includes a command code, AAR, a subscriber ID, which in this case is 16038889999, and a time stamp, March 4 at 8:51 am. When the logic stored in the processor 606 reads the database 608, it analyzes the information associated with subscriber ID 16038889999 in order to determine the IP address of the partition of the PCRF 530 to which it should forward the call/message. In this example, the information stored in the database indicates that the first message 541 should be forwarded to partition A 531 of the PCRF 530 having an IP address of 172.17.0.2. Given that the Diameter protocol mandates that an acknowledgement must be sent for all requests, FIG. 5 shows partition A 531 of the PCRF 530 sending an acknowledgement response back to the Diameter routing agent 520, which in turn relays the acknowledgement back to the server 510.

Similarly, the server, or AF, 510 sends a second message 542 that is destined for partition B 532 of the PCRF 530, which has an IP address of 172.17.0.4. The second message 542 is an AAR message having a subscriber ID of 16038886666 and a time stamp of 8:51 am on March 4^{th}. In response to receiving the AAR request, Segment B 532 of the PCRF 530 sends an acknowledgement message to the Diameter Routing Agent 520, which in turn forwards the acknowledgement to the AF 510.

FIG. 6 is a flow chart showing the steps of how we automatically generate the middleware for the control plane according to one generalized embodiment of the present invention. As can be seen in FIG. 6, the following steps are used to automate call flow creation within a wireless network operating on a Diameter protocol or one of the various Diameter protocol extensions known to those of skill in the art. Initially, this embodiment reads 610 a finite state machine which has a historic call log stored therein, the historic call log comprising metadata for one or more messages transmitted or received within the wireless network. Using the metadata, this embodiment determines 620, on a message-by-message basis, where to route each message. After making this determination, this embodiment routes 630 the message to an intended wireless network element. In the Diameter protocol, all messages routed within the network have an accompanying acknowledgement message that is sent when the message is properly received. In this way, the network is able to keep track of any messages that may have been lost. Accordingly, the final step for the general embodiment of automating the call flow entails receiving 640 an acknowledgement message indicating that the message was received by the intended wireless network element.

Those of skill in the art will recognize throughout this specification that when like terms are used to describe features and functionalities of various portions of a particular embodiment, those same features and functionalities could be present in additional embodiments having aspects with like terms.

The articles “a” and “an” as used herein in the specification and in the claims, unless clearly indicated to the contrary, should be understood to include the plural referents. Claims or descriptions that include “or” between one or more members of a group are considered satisfied if one, more than one, or all of the group members are present in, employed in, or otherwise relevant to a given product or process unless indicated to the contrary or otherwise evident from the context.

The invention includes embodiments in which exactly one member of the group is present in, employed in, or otherwise relevant to a given product or process. The invention also includes embodiments in which more than one or the entire group of members is present in, employed in or otherwise relevant to a given product or process. Furthermore, it is to be understood that the invention encompasses all variations, combinations, and permutations in which one or more limitations, elements, clauses, descriptive terms, etc., from one or more of the listed claims is introduced into another claim dependent on the same base claim (or, as relevant, any other claim) unless otherwise indicated or unless it would be evident to one of ordinary skill in the art that a contradiction or inconsistency would arise.

Where elements are presented as lists, (e.g., in Markush group or similar format) it is to be understood that each subgroup of the elements is also disclosed, and any element(s) can be removed from the group. It should be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in so many words herein. It should also be understood that any embodiment or aspect of the invention can be explicitly excluded from the claims, regardless of whether the specific exclusion is recited in the specification. The entire contents of all of the references (including literature references, issued patents and published patent applications and websites) cited throughout this application are hereby expressly incorporated by reference.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification, embodiments have been described in a way which enables a clear and concise specification to be written, but it is intended and will be appreciated, that embodiments may be variously combined or separated without departing from the invention. It is intended that the present invention be limited only to the extent required by the appended claims and the applicable rules of law.

What is claimed is:

1. A computer implemented method for automating a call flow in a Diameter wireless network using a Diameter protocol using a processor executing a process to perform one or more steps, the steps comprising:
a. reading a finite state machine having a historic call log stored therein, the historic call log comprising metadata for one or more messages transmitted or received within the wireless network;
b. determining on a message-by-message basis, from the metadata, where to route each message;
c. routing the message to an intended wireless network element; and
d. receiving an acknowledgement that the message was received by the intended wireless network element.

2. The computer implemented method of claim 1 wherein the message is routed to a partition within a network element.

3. The computer implemented method of claim 1 wherein a determination of where to route the message is made based on one or more of the following: log entry number, subscriber ID, subscriber ID type, IPv6 Prefix, source ID, destination ID, Target Server IP address, Target Server Port, Hop ID, End ID, Application ID, Session ID, Authorization Application ID, Origin Host, origin Realm, Destination Host, Destination Realm, Media Host Description Indicators, Service Information Status, SIP Forking Indication, Specific Action, Service URN, Sponsored Connectivity Data, MPS Identifier, GCS Identifier, Protocol Request Type, Required Access Information, Origin State ID, Proxy Information, Route Record, IP Domain ID, Subscription ID, Reservation Priority, Called Station ID, Framed IP Address, Framed IPv6 Prefix, or Supported Features.

4. The computer implemented method of claim 1 wherein a determination of where to route the message is made based on one or more of the following: application ID, the command code or an additional attribute on the payload.

5. The computer implemented method of claim 1 further comprising the step of dynamically coupling to a home subscriber server in order to obtain the metadata for an out-of-network user.

6. The computer implemented method of claim 5 further comprising the step of storing the metadata for the out-of-network subscriber in the finite state machine.

7. A computer hardware system comprising a hardware processor including a code generator wherein the hardware processor is configured to initiate or perform:
a. reading a finite state machine having a historic call log stored therein, the historic call log comprising metadata for one or more messages transmitted or received within the wireless network;
b. determining on a message-by-message basis, from the metadata, where to route each message;
c. routing the message to an intended wireless network element; and
d. receiving an acknowledgement that the message was received by the intended wireless network element.

8. The computer hardware system of claim 7 wherein the message is routed to a partition within a network element.

9. The computer hardware system of claim 7 wherein a determination of where to route the message is made based on one or more of the following: log entry number, subscriber ID, subscriber ID type, IPv6 Prefix, source ID, destination ID, Target Server IP address, Target Server Port, Hop ID, End ID, Application ID, Session ID, Authorization Application ID, Origin Host, origin Realm, Destination Host, Destination Realm, Media Host Description Indicators, Service Information Status, SIP Forking Indication, Specific Action, Service URN, Sponsored Connectivity Data, MPS Identifier, GCS Identifier, Protocol Request Type, Required Access Information, Origin State ID, Proxy Information, Route Record, IP Domain ID, Subscription ID, Reservation Priority, Called Station ID, Framed IP Address, Framed IPv6 Prefix, or Supported Features.

10. The computer hardware system of claim 7 wherein a determination of where to route the message is made based on one or more of the following: application ID, the command code or an additional attribute on the payload.

11. The computer hardware system of claim 7 further comprising the step of dynamically coupling to a home subscriber server in order to obtain the metadata for an out-of-network user.

12. The computer hardware system of claim 11 further comprising the step of storing the metadata for the out-of-network subscriber in the finite state machine.

13. A computer program product embodied in a non-transitory computer readable medium, the computer readable medium having stored thereon a sequence of instructions which, when executed by a processor causes the processor to execute a process, the process comprising:
a. reading a finite state machine having a historic call log stored therein, the historic call log comprising metadata for one or more messages transmitted or received within the wireless network;
b. determining on a message-by-message basis, from the metadata, where to route each message;
c. routing the message to an intended wireless network element; and
d. receiving an acknowledgement that the message was received by the intended wireless network element.

14. The computer program product of claim 13 wherein the message is routed to a partition within a network element.

15. The computer program product of claim 13 wherein a determination of where to route the message is made based on one or more of the following: log entry number, subscriber ID, subscriber ID type, IPv6 Prefix, source ID, destination ID, Target Server IP address, Target Server Port, Hop ID, End ID, Application ID, Session ID, Authorization Application ID, Origin Host, origin Realm, Destination Host, Destination Realm, Media Host Description Indicators, Service Information Status, SIP Forking Indication, Specific Action, Service URN, Sponsored Connectivity Data, MPS Identifier, GCS Identifier, Protocol Request Type, Required Access Information, Origin State ID, Proxy Information, Route Record, IP Domain ID, Subscription ID, Reservation Priority, Called Station ID, Framed IP Address, Framed IPv6 Prefix, or Supported Features.

16. The computer program product of claim 13 wherein a determination of where to route the message is made based on one or more of the following: application ID, the command code or an additional attribute on the payload.

17. The computer program product of claim 13 further comprising the step of dynamically coupling to a home subscriber server in order to obtain the metadata for an out-of-network user.

18. The computer program product of claim 17 further comprising the step of storing the metadata for the out-of-network subscriber in the finite state machine.
